(19) United States
(12) Patent Application Publication
(10) Pub. No.: US 2013/0100426 A1
(43) Pub. Date: Apr. 25, 2013

(54) METHOD FOR PRODUCING FACET MIRRORS AND PROJECTION EXPOSURE APPARATUS

(71) Applicant: CARL ZEISS SMT GMBH, Oberkochen (DE)

(72) Inventors: Berndt Warm, Schwaig (DE); Siegfried Rennon, Wuerzburg (DE); Guenther Dengel, Heidenheim (DE); Juergen Baier, Oberkochen (DE); Udo Dinger, Oberkochen (DE); Stefan Burkart, Heidenheim (DE); Christos Kourouklis, Aalen (DE); Hin Yiu Chung, Ulm (DE); Stefan Wiesner, Lauchheim (DE); Hartmut Enkisch, Aalen (DE)

(73) Assignee: CARL ZEISS SMT GMBH, Oberkochen (DE)

(21) Appl. No.: 13/683,138

(22) Filed: Nov. 21, 2012

Related U.S. Application Data
(63) Continuation of application No. 12/504,844, filed on Jul. 17, 2009, now abandoned.
Application No. 12/504,844 is a continuation of application No. PCT/EP2008/001247, filed on Feb. 18, 2008.

(30) Foreign Application Priority Data
Feb. 19, 2007 (DE) 102007008448.1

(51) Int. Cl. G02B 5/08

(52) U.S. Cl. CPC G02B 5/08
USPC 355/30

(57) ABSTRACT

The disclosure relates to methods for producing mirrors, in particular facet mirrors, and projection exposure apparatuses equipped with the mirrors.

### CROSS-REFERENCE TO RELATED APPLICATIONS

This application is a continuation of, and claims priority under 35 USC 120 to, U.S. application Ser. No. 12/504,844, filed Jul. 17, 2009, which claims benefit under 35 USC 120 to, international application PCT/EP2008/001247, filed Feb. 18, 2008, which claims benefit of German Application No. 10 2007 008 448.1, filed Feb. 19, 2007. U.S. application Ser. No. 12/504,844 and international application PCT/EP2008/001247 are hereby incorporated by reference in their entirety.

### FIELD

The disclosure relates to facet mirrors, methods for producing facets for a facet mirror and to related facet mirrors, as well as projection exposure apparatuses and illumination systems for projection exposure apparatuses in semiconductor lithography. Facet mirrors of this type can be used for producing specific spatial illumination distributions in illumination systems for EUV projection exposure apparatuses at a working wavelength of 13 nm.

### BACKGROUND

In some instances, an illumination system for a projection exposure apparatus shapes and uniformly illuminates the object field of a projection objective. In addition, the illumination system may also shape the pupil of the projection objective and, while complying with fixed pupil positions, fill it with light in a relatively uniform manner. The pupil filling can vary depending on the application.

### SUMMARY

In some embodiments, the disclosure provides a method for producing mirror facets for a facet mirror which permits the economic production of mirror facets with high angular accuracy and at the same time low surface roughness. In certain embodiments, the disclosure provides projection exposure apparatuses, in particular for EUV lithography, which are equipped with mirrors having positive optical properties.

In some emeobidments, an EUV projection exposure apparatus has a facet mirror that includes mirror facets arranged on carrying elements. The mirror facets can have a thickness of less than 2 mm, such as within the range of 0.2 mm-1.2 mm. The carrying elements can be a basic body common to a plurality of mirror facets or else intermediate pieces or so-called bottom facets, which are connected to a carrier body. The small thickness of the mirror facets has the effect that the mirror facets can exhibit shape flexibility and can be adapted within certain limits to the shape of the carrying element on which they are arranged. Possible shape deviations of the mirror facets that originate from the fabrication process can be compensated for in this way, without certain optical properties, such as the reflectivity and the surface quality of the mirror facets, being impaired thereby.

In some embodiments, the connection of the mirror facets to the carrying elements can be achieved by a soldering layer having a thickness within the range of 2-10 μm, such as within the range of 3-7 μm. The thinner the soldering layer is made, the better the heat transfer can be between the mirror facet and the carrying element and cooling devices possibly present. Since the facet mirror is operated in a vacuum, cooling via the carrying element can be highly desirable because, otherwise, thermal energy may be dissipated to the surroundings only by way of radiation but not by way of convection.

In certain embodiments, the mirror facets can be connected to the carrying elements by an inorganic layer containing silicon oxide bridges. Such a layer can be produced by the so-called “low-temperature bonding” method. In this method, the joining partners can be brought into contact using a basic solution, e.g. a KOH solution, and SiO₂, whereby the silicon oxide bridges are formed.

In some embodiments, the mirror facets can also be connected to the carrying elements by a bonding or an adhesive layer.

The mirror facets can have a reflective surface with a multilayer, such as a multilayer including Mo/Si double layers.

A multilayer can have approximately 10-80, such as 50 double layers. The thickness of a Mo/Si double layer can be 6.8-15 nm, and the thickness of a Mo layer can be 1.3 nm-12 nm. The total thickness of a double layer can vary perpendicular to the layer course of the multilayer. This can provides a so-called “chirp”. This can reduce the angle dependence of the reflectivity of the multilayer, although this could be detrimental of the total reflectivity.

At least two mirror facets can be connected to a common, integral basic body, which in this case can serve as a carrying element. The basic body can have differently oriented areas for receiving the mirror facets. Moreover, the connection to the basic body can be formed by suitably dimensioned intermediate pieces as carrying elements.

In some embodiments, all the mirror facets of the facet mirror can be arranged on a common, integral basic body.

The basic body can be composed of the same material as the uncoated mirror facet. In some cases, the basic body can be at least partly composed of Si.

The mirror facet can furthermore be composed of an optically polishable material, in which a surface roughness of less than 0.5 nm rms, such as less than 0.2 nm rms, can be achieved in the high spatial frequency (HSFR) range. In this case, the carrying element can be composed of a material having a thermal conductivity of at least 100 W/(mK), such as a metallic material or SiC.

By way of example, the mirror facets can contain Si, SiO₂, NiP or NiP-coated metal or SiC.

In certain embodiments, the facet mirror is arranged in the illumination system of the EUV projection exposure apparatus.

Cavities, such as in the form of grooves, can be formed in the region between the mirror facet and the carrying element. Optionally, the cavities can be connected to coolant lines.

In some embodiments, the disclosure provides an EUV projection exposure apparatus having a mirror element arranged on a carrying element. The mirror element can be composed of an optically polishable material, in which a surface roughness of 0.5 nm rms, such as 0.1 nm rms, can be achieved in the high spatial frequency (HSFR) range. The carrying element can be composed of material having a thermal conductivity of at least 100 W/(mK), such as a metallic material or SiC.

The mirror element can be a mirror facet formed as part of a facet mirror arranged in the illumination system of the apparatus.

The mirror element can contain Si, for example. The mirror element can have a thickness within the range of 0.2-5 mm, such as within the range of 1-3 mm. In some embodiments, the mirror element can also be formed as a nickel-coated steel body.

The carrying element can be arranged on a carrier body that is movable, such as tiltable, with respect to the carrier body.

The carrying element and the carrier body can be formed from the same material, such as from a steel (e.g., invar). This can help ensure an improved heat transfer from the carrying element to the carrier body. The carrying element and the carrier body can be polished in the region of their respective contact areas. Fabrication of the carrier body and/or the carrying element from Cu or Al is also possible.

The heat transfer between the mirror element and the carrying element can be enhanced by the mirror element and the carrying element being connected to one another by a soldering connection. In some embodiments, this involves the mirror elements being connected to the carrying elements by an inorganic layer containing silicon oxide bridges. Such a layer can be produced, for example, by a low-temperature bonding method. In the method, the joining partners are brought into contact using a basic solution, such as a KOH solution, and SiO₂, whereby the silicon oxide bridges are formed.

A reduction of the influence of the different coefficients of thermal expansion of mirror element and carrying element can be achieved, for example, by cavities, such as grooves, in the region between the mirror element and the carrying element. With such an arrangement, the mirror element and the carrying element are connected to one another not over the whole area, but rather via webs or pillar-like projections. The webs or projections have the effect that the deformations that arise on account of the different coefficients of thermal expansion in the arrangement do not reach, or reach only to a reduced extent, the optically active surface of the mirror element, but rather are essentially absorbed by a deformation of the webs or projections.

The cavities produced in this way can be connected to coolant lines, whereby an active cooling of the arrangement is made possible.

In certain embodiments, a mirror element can be wedge-shaped or spherical fashion. This can provide, for example, the possibility of setting an angular offset beforehand, for example, as early as during production. The desire for tiltability with respect to the carrier body can be reduced in this way, for example, for selected mirror elements on their carrying elements.

The mirror element can be a substantially circular lamina having a diameter within the range of between 2 mm-15 mm, such as within the range of between 8 mm-12 mm.

In some embodiments, to help reduce the effect of temperature changes on the optically active surface of the mirror element, the mirror element and the carrying element can be connected to one another by a connecting layer composed of a connecting material having a modulus of elasticity of <70 MPa. In this case, the connecting layer can act in the manner of an expansion joint. Particularly in combination with the cavities mentioned above, it is thus possible to achieve further improved deformation decoupling.

The mirror elements can have a reflective surface with a multilayer, such as composed of Mo/Si double layers. The multilayer has approximately 10-80, such as 50 double layers. The thickness of a Mo/Si double layer can be 6.8-15 nm. The thickness of a Mo layer is 1.3 nm-12 nm.

In certain embodiments, the disclosure provides a method for producing overall facets for a facet mirror. The method includes fabricating the mirror facets in each case separately from one another as mirror facets and bottom facets. The mirror facets acquire a polished surface and are arranged on a basic body by a bottom facet. The angular orientation of the polished surface with respect to a reference area of the basic body is predetermined. The desired accuracy of the angular orientation can be achieved by performing a measurement of the angular orientation of a mirror facet and subsequently providing a matching bottom facet.

The matching bottom facet can be selected from a plurality of prefabricated bottom facets by an angle measurement or be fabricated in a manner adapted to the geometry of the mirror facet.

The bottom facets and the mirror facets can be connected to one another to form overall facets by a bonding method.

It is also possible to connect the bottom facets to the basic body by a bonding method.

The overall facets can be connected to form blocks by a bonding method, such as, prior to mounting on the basic body. The angular orientation of the polished surfaces of the mirror facets can be measured after the overall facets have been connected to form blocks.

It can be advantageous if that area of the bottom facet which faces the mirror facet contains a larger area than that area of the mirror facet which faces the bottom facet.

For the basic body it is possible to choose the same material as for the mirror or bottom facet, which can in particular also be formed in arcuate fashion. For example, the basic body, the mirror facet or the bottom facet can contain silicon.

The mirror facet can have a thickness of less than 2 mm, such as within the range of 0.2 mm-1.2 mm.

The mirror facet can be composed of an optically polishable material in which a surface roughness of less than 0.5 nm rms, such as less than 0.2 nm rms, can be achieved in the high spatial frequency (HSFR) range. The bottom facet can be composed of a material having a thermal conductivity of at least 100 W/(mK), such as a metallic material.

Cavities, such as grooves, can be formed in the region between the mirror facet and the bottom facet. The cavities can be connected to coolant lines.

Method disclosed herein can allow for the production of facet mirrors to be simplified considerably and thus to be made less expensive.

### BRIEF DESCRIPTION OF THE DRAWINGS

Exemplary embodiments of the disclosure are explained in more detail below with reference to the drawings, in which:

FIG. 1 shows a facet mirror in a projection exposure apparatus with an illumination system,

FIG. 2 shows the principle of the disclosure using the example of a perspective illustration of an excerpt from a facet mirror,

FIG. 3 shows a perspective illustration of a basic body,

FIG. 4 shows, in subfigures 4a and 4b, variants for the configuration of the basic body with bearing areas and mirror facets,

FIG. 5 shows a mirror element,

FIG. 6 shows an embodiment in which cutouts, such as grooves, are arranged in the region of the contact area between the mirror facet and the carrying element,

FIG. 7 shows an alternative to the solution illustrated in FIG. 6,

FIG. 8 shows a variant of the disclosure in which the solution is applied for a monolithic mirror, for example of an EUV projection exposure system,

FIG. 9 shows a facet mirror with a basic body and overall facets arranged thereon,

FIG. 10 shows a variant of the disclosure in which the overall facet is formed from a mirror facet and a bottom facet,

FIG. 11 shows the distribution of the angles of the surfaces of the mirror and bottom facets,

FIG. 12 shows the arrangement of the mirror facets on a polishing carrying body in figure part 12a in a plan view and in figure part 12b as a cross-sectional illustration,

FIG. 13 shows a self-explanatory flow diagram of a method,

FIG. 14 shows, in subfigures 14a and 14b, respectively, the geometrical properties of the mirror and bottom facets,

FIG. 15 shows overall facets combined to form blocks,

FIG. 16 shows the arrangement of the blocks of the overall facets on the basic body in a first viewing direction, and

FIG. 17 shows the arrangement of the blocks of the overall facets on the basic body in a second viewing direction, which is perpendicular to the first viewing direction.

### DETAILED DESCRIPTION

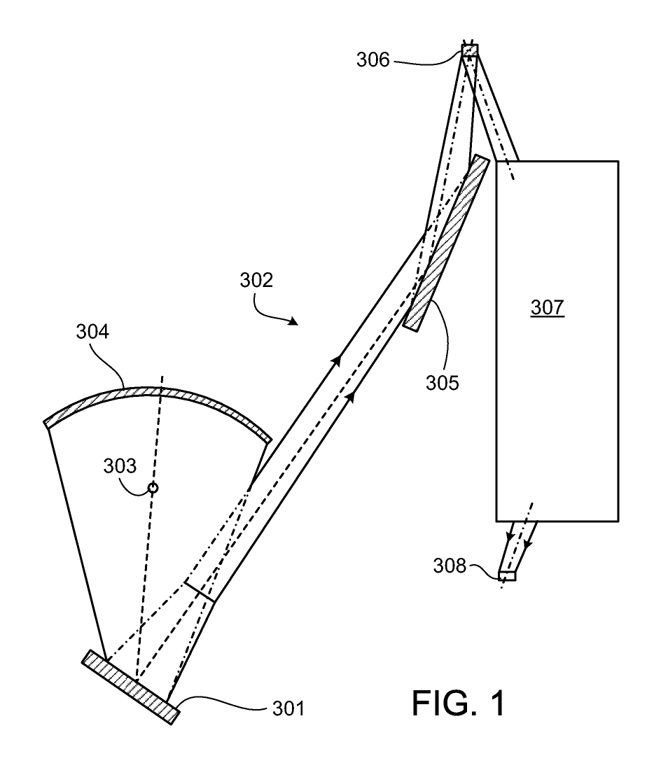

FIG. 1 illustrates a facet mirror 301 in a projection exposure apparatus with an illumination system 302. The light from a light source 303, for example a plasma source, is deflected via a collector mirror 304 onto the facet mirror 301, from where it is fed with a desired uniform illumination via a deflection mirror 305 to a reticle 306. The pattern of the reticle 306 is transferred via a projection objective 307 (not illustrated in specific detail) with optical elements to a wafer 308 for highly demagnified imaging of the image of the reticle 306.

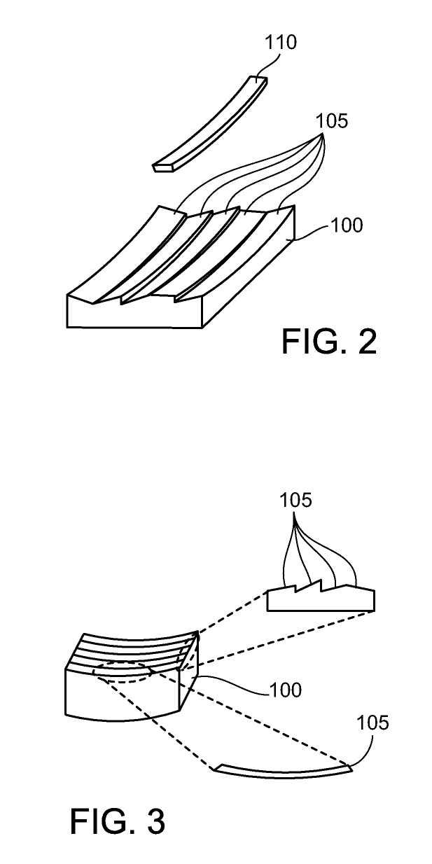

FIG. 2 schematically shows a feature of the disclosure on the basis of the example of a perspective illustration of an excerpt from a facet mirror. A plurality of bearing areas 105 each having different tilt angles are arranged on the basic body 100 of the facet mirror, the mirror facets 110 being applied to the areas in the arrow direction. It can be discerned from FIG. 1 that the mirror facets 110 are made comparatively thin with respect to the basic body 100; a typical thickness of the mirror facets is approximately 1 mm. What is achieved by the configuration of basic body 100 and mirror facet 110 is that the mirror facet 110, in the course of being joined on the basic body 100, can be adapted within certain limits to the surface shape and orientation of the bearing areas 105 on the basic body 100. In this way, fabrication-dictated shape deviations of the mirror facets 110 can be compensated for by the basic body 100. The mirror facet illustrated in FIG. 2 has a length of approximately 40-100 mm and a width of approximately 1-10 mm.

FIG. 3 shows for illustration purposes once again a perspective illustration of the basic body 100. FIG. 3 reveals that the bearing areas 105 can have different tilt angles or else different radii of curvature. The bearing areas 105 can in particular also be configured as freeform areas; it is likewise conceivable for the bearing areas 105 to exhibit a simpler geometry, for example planar geometry or else geometry in the shape of a lateral surface of a cylinder.

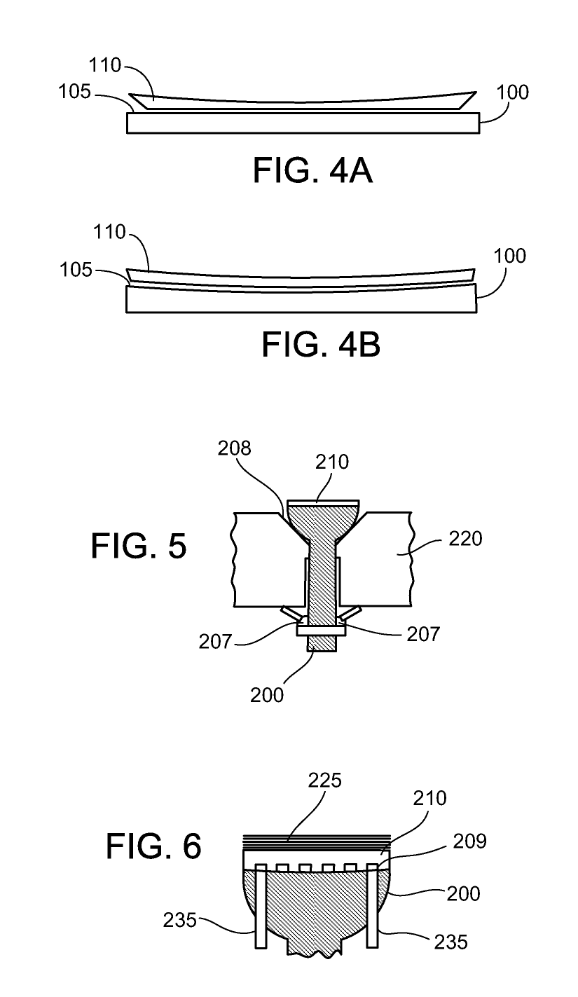

FIG. 4 once again shows, in subfigures 4a and 4b, variants for the configuration of the basic body 100 with the bearing areas 105 and the mirror facets 110. FIG. 4a illustrates the variant that the basic body 100 exhibits a planar bearing area 105, on which the mirror facet 110 is arranged by its likewise planar rear side. In contrast to this, FIG. 4b shows a basic body 100 having a curved bearing area 105, into which the likewise curved rear side of the mirror facet 110 is fitted.

FIG. 5 shows the mirror element formed as a mirror facet 210 arranged on the stamp-type carrying element 200. In this case, the carrying element 200 is mounted on the carrier body 220 and can be tilted together with the mirror facet 210 with respect to the carrier body 220 by the schematically illustrated actuator system 207. In this case, in the present exemplary embodiment, both the carrier body 220 and the carrying element 200 are formed from steel. Furthermore, the bearing area 208 of the carrying element 200 on the carrier body 220 is worked mechanically with high precision, thereby ensuring a good thermal contact and mobility of the carrying element 200 in the carrier body 220 with the least possible friction. This helps to ensure, among other things, that the heat input into the mirror facet 210 on account of the incident EUV radiation can be efficiently dissipated via the carrying element 200 into the carrier body 220. In contrast to the material of the carrier body 220 and of the carrying element 200 that can be chosen optimally with regard to mechanical processability and thermal conductivity, the material of the mirror facet 210 can be optimized so as to result in a good surface polishability and hence a high reflectivity. In the present example, the mirror facet 210 is composed of silicon connected to the carrying element 200 by a soldering layer based on indium, for example, the soldering layer not being illustrated in FIG. 4. Since the silicon of the mirror facet 210 and the steel of the carrying element 200 have a mutually different coefficient of thermal expansion, it may be advantageous to avoid the resultant problem by the measure illustrated in FIG. 5.

FIG. 6 shows an embodiment of the disclosure in which cutouts, in particular grooves 209, are arranged in the region of the contact area between the mirror facet 210 and the carrying element 200. The grooves 209 have the advantage that the stresses and associated expansions that accompany heating with different coefficients of thermal expansion affect the reflective surface of the mirror facet 210 to a lesser extent and therefore impair the optical quality of the mirror facet 210 to a lesser extent than would be the case with a whole-area connection between mirror facet 210 and carrying element 200. The groove-type cutouts 209 illustrated furthermore afford the option of allowing a coolant such as water, for example, to flow through them, whereby the thermal problem outlined is furthermore alleviated; the corresponding coolant lines 235 are indicated schematically. The solution illustrated in FIG. 6 therefore extends the spectrum of materials that are appropriate for the mirror facet 210 and the carrying element 200, since the coefficients of thermal expansion of the materials used are permitted to deviate from one another in a larger range. For further illustration, the multilayer 225 arranged on the mirror facet 210 is illustrated purely schematically and not as true to scale in FIG. 6.

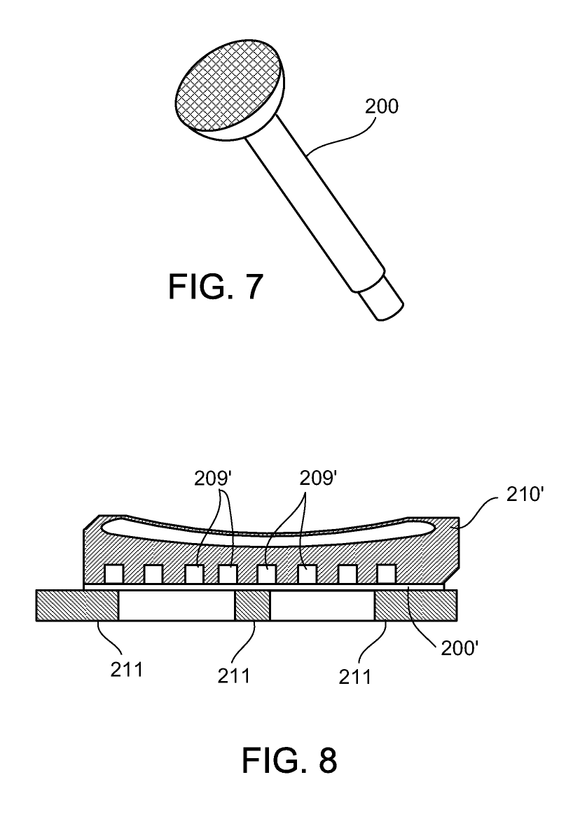

In some embodiments, the groove-type cutouts 209 are worked from the mirror facet 210 as illustrated, for example, in FIG. 7, which shows in a perspective illustration a stamp-type carrying element 200, having a grid-type groove structure worked into its surface facing the mirror facet (not illustrated).

The variants illustrated in FIGS. 2 to 7 concern mirror facets for facet mirrors which can include hundreds of the mirror facets. By contrast, FIG. 8 shows a monolithic mirror, for example of an EUV projection exposure system. In this case, the mirror element 210′ is formed as a monolithic silicon element having a polished surface, the element being applied on the carrying element 200′ formed from steel. In this case, too, groove-type cutouts 209′ are worked from the mirror element 210′ on the rear side and coolant can likewise flow through them. The carrying element 200′ with the mirror element 210′ is arranged on the bearing elements 211. The mirror illustrated in FIG. 7 can not only be used in applications for EUV lithography but it is likewise also suitable for astronomical telescopes.

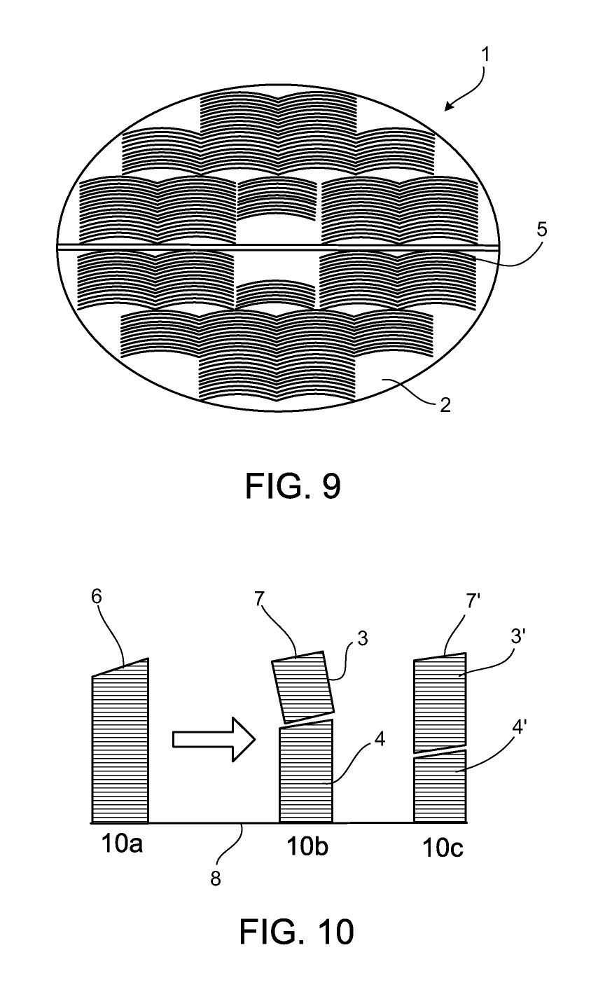

For illustrating the geometrical relationships of a further variant of the disclosure, FIG. 9 shows a facet mirror 1 with a basic body 2 and overall facets 5 arranged thereon. In this case, the overall facets 5 are formed in arcuate fashion and arranged in groups on the basic body 2 of the facet mirror 1. In this case, hundreds of overall facets 5 can be fitted on the basic body 2; approximately 300 overall facets 5 are shown in the example illustrated in FIG. 1.

FIG. 10 illustrates a basic principle of a variant of the disclosure discussed. In contrast to a certain known monolithically produced integral overall facet 6, which is illustrated in figure part 10a on the left, the overall facet 5 is formed from a mirror facet 3 and a bottom facet 4 or a mirror facet 3′ and a bottom facet 4′. Subfigure 10b illustrates a first variant regarding how a predetermined angle can be set between the polished surface 7 at the reference area of the basic body 8. In this case, the mirror facet 3 is realized essentially with a rectangular cross section and the area facing the mirror facet 3 is oriented with the desired angle with respect to the reference area of the basic body 8. As an alternative it is also possible, as illustrated in subfigure 10c, to form the mirror facet 3′ with a cross section corresponding to a parallelogram. In this case, too, it is possible to achieve a correct orientation of the polished surface 7′ with respect to the reference area of the basic body 8.

In the example shown in FIG. 10, the polished surface 7 or 7′ of the mirror facet 3 or 3′, respectively, has the desired surface roughness. Owing to the method, that surface of the mirror facet 3 or 3′ which faces the bottom facet 4 or 4′, respectively, cannot be configured with a sufficiently accurate orientation with regard to its angle. The desired orientation of the polished surface 7 or 7′ with respect to the reference area of the basic body 8 is now achieved by providing, i.e. either fabricating or selecting, the bottom facet 4 or 4′, respectively, in a suitable manner. In this case, the two surfaces of the bottom facet and of the mirror facet which face one another can be plane and planar or else spherical; the bottom facet 4 or 4′ and/or the mirror facet 3 or 3′, respectively, can be composed of silicon.

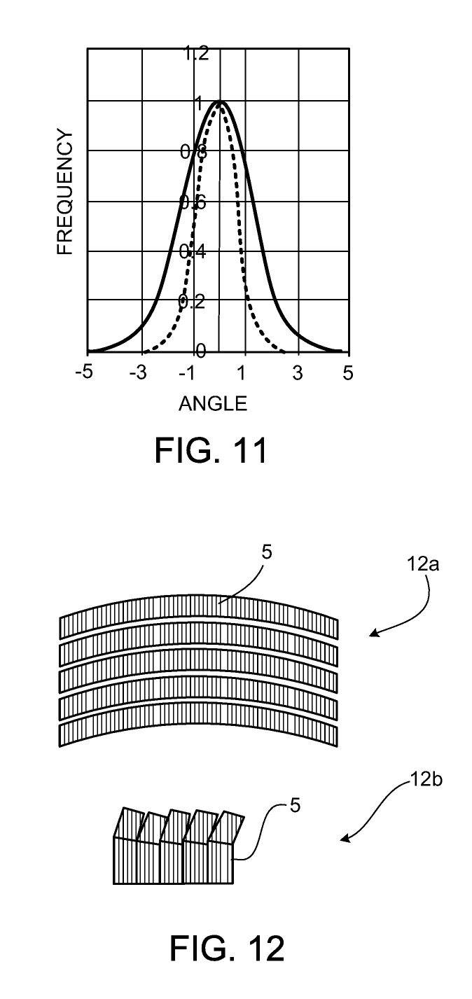

During the fabrication of the bottom facets 4 and 4′ and the mirror facets 3 and 3′, respectively, the angles of the finally processed areas vary in Gaussian fashion around a desired angle in the case where a relatively large number of facets are fabricated. The corresponding distribution of the angles of the surfaces is illustrated schematically in FIG. 11. In this case, the solid curve indicates the variation of the angles of the surface of the bottom facet, while the dashed curve indicates the angular distribution of the surface of the mirror facet. The distributions ideally lie one above another. In this case there is the possibility of finding, for example for a mirror facet whose surface has an angle that deviates by a specific magnitude from the desired angle set (in the region of the axis of symmetry of the curve), a bottom facet which precisely compensates for this error such that a correct orientation of the polished surface 7 or 7′ with respect to the reference area 8 of the basic body is produced as a result. Therefore, firstly the angular orientation of the polished surface 7 or 7′ of the mirror facet 3 or 3′, respectively, is measured and afterward the matching bottom facet 4 or 4′, respectively, is likewise selected by an angle measurement. Consequently, the errors originating from inaccuracies in fabrication can be compensated for just through skilful selection of the two facets to be connected. It is advantageous if the mirror facets 3 and 3′ are produced in a higher number than the bottom facets 4 and 4′, respectively; this effectively avoids a situation in which possibly no pairs can be assembled for individual desired overall facets with the correct angular orientation of the reflective surface 7. In the case of fabricating facets for a plurality of facet mirrors it is desirable anyway to provide a very high number of mirror facets 3 and 3′ and bottom facets 4 and 4′, respectively, beforehand, such that special fabrications are not necessary.

In this case, the polished surfaces 7 of the mirror facets 3 and 3′ can be produced by a comparatively large mirror being polished and the arcuate mirror facets being cut out from the mirror by erosion. As an alternative, finished cut-to-size arcuate facets can be arranged in densely packed fashion on a polishing carrying body and subsequently be polished jointly; this method affords the advantage that it is considerably more cost-effective than the method described previously. FIG. 12 shows the arrangement of the mirror facets 3 on the polishing carrying body in figure part 12a in a plan view and in figure part 12b as a cross-sectional illustration.

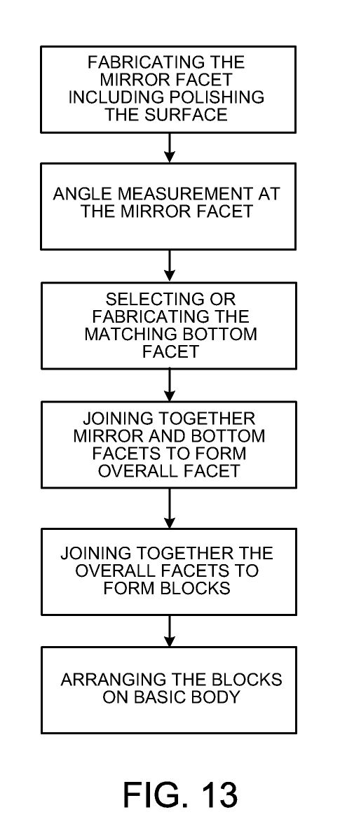

FIG. 13 shows a flow diagram of a method.

Some embodiments can involve first selecting a mirror facet 3 or 3′ and accurately measuring it with regard to its angular orientation. It is then possible to define the angles with which the surfaces of the associated bottom facet 4 or 4′, respectively, have to be fabricated in order to ensure a correct orientation of the polished surface 7 with respect to the reference area of the basic body 8 as a result. The bottom facet 4 or 4′ can then be ground with an accuracy of a few tens of seconds in such a way as to produce the matching angle.

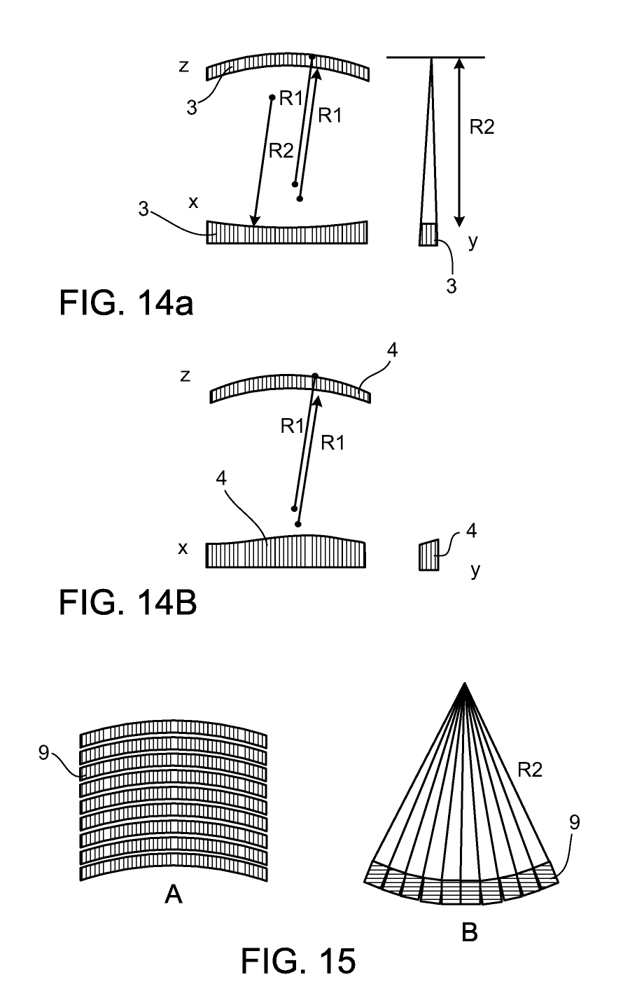

For further illustration, FIG. 14 illustrates the geometrical properties of the mirror and bottom facets 3 and 4, respectively. In this case, FIG. 14a shows a mirror facet 3 and FIG. 14b shows a bottom facet 4 in each case from x, y and z directions with the corresponding radii R1 and respectively R2 of curvature.

After the pairs of mirror and bottom facets 3, 3′, 4, 4′ have been provided, these are combined to form overall facets using a bonding method. Such methods can be used very well for crystals such as silicon, in particular; this results in a very fixed, permanent connection having good thermal conductivity. The mirror facets can be coated prior to being combined to form overall facets or else at some other suitable point in time in the process. The overall facets are then combined to form blocks 9, as are illustrated in FIG. 15. These blocks can also be discerned arranged on the basic body 2 in FIG. 1. FIG. 15 shows the blocks 9 in a plan view in the left-hand part of the figure and in a cross-sectional illustration in the right-hand part of the figure. The bonding method can advantageously be used also for combining the overall facets 5 to form the blocks 9. In this case, the angles of the surfaces of the overall facets 5 of each block 9 are checked after mounting. Arranging the overall facets 5 to form blocks 9 affords the advantage that in the event of faults in the assembly, only the corresponding block 9 rather than the entire facet mirror is faulty. Gaps naturally remain between the overall facets 5 in the facet mirror since each overall facet 5 has its own predetermined angle. The dimensions of the gaps are within the range of a few tens of micrometers. However, this problem can be minimized by the optical design being suitably chosen by a corresponding selection of the angles of the overall facets that lie alongside one another. In order to ensure a good cohesion of the blocks 9 and a good thermal conductivity between the blocks 9, the bottom facets 4 and 4′ are provided with somewhat larger dimensions than the mirror facets 3 and 3′, respectively. In this way, no gaps remain between the bottom facets 4 and 4′. After the blocks 9 have been produced in accordance with the method described above, they are placed onto the reference area 8 of the basic body and either fixed there once again with the aid of a bonding method or else screwed there. In this case, the basic body is composed of the same material as the overall facets 5, that is to say of silicon in the present example.

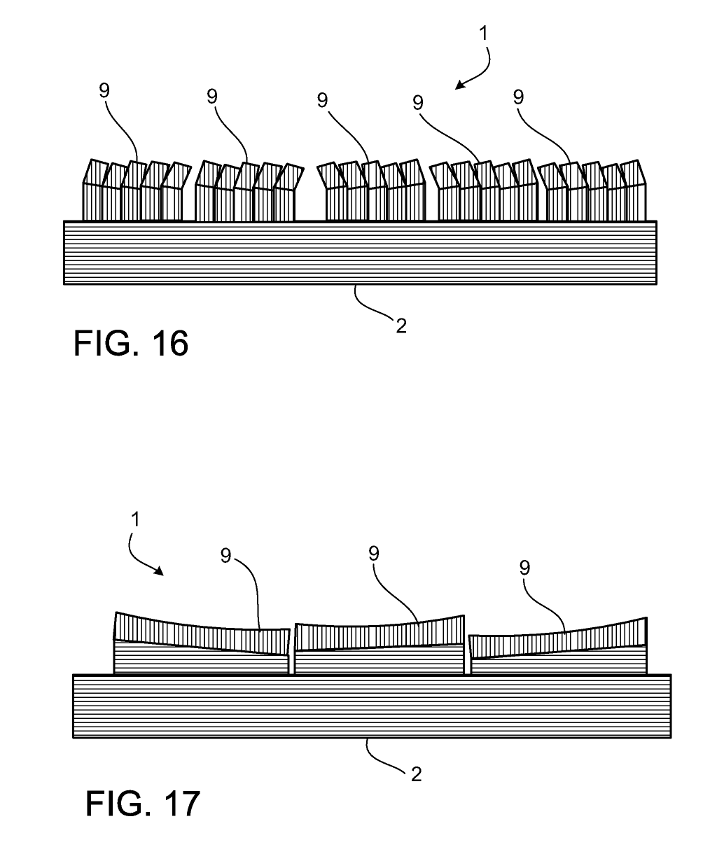

FIGS. 16 and 17 show, in a cross-sectional illustration, the arrangement of the blocks 9 of the overall facets 5 on the basic body 2 from two viewing directions that are perpendicular to one another.

What is claimed is:

1. An apparatus, comprising:
a carrying element;
a mirror element carried by the carrying element; and
coolant lines connected to cavities defined by a region between the mirror element and the carrying element,
wherein:
the carrying element comprises a material having a thermal conductivity of at least 100 W/(mK);
the mirror element comprises an optically polishable material having a surface roughness of less than 0.5 nm rms in the high spatial frequency range;
the mirror element has a thickness within the range of 0.2 mm to 5 mm; and
the apparatus is an EUV projection exposure apparatus.

2. The apparatus of claim 1, wherein the surface roughness of the optically polishable materials is 0.2 nm rms in the high spatial frequency range.

3. The apparatus of claim 2, wherein the material having the thermal conductivity of at least 100 W/mK is a metallic material.

4. The apparatus of claim 3, wherein the mirror element has a thickness within the range of one mm to three mm.

5. The apparatus of claim 4, wherein the cavities are grooves.

6. The apparatus of claim 1, wherein the material having the thermal conductivity of at least 100 W/mK is a metallic material.

7. The apparatus of claim 1, wherein the mirror element has a thickness within the range of one mm to three mm.

8. The apparatus of claim 1, wherein the cavities are grooves.

9. The apparatus of claim 1, wherein the apparatus comprises an illumination system, the illumination system comprises a facet mirror, and the mirror element is a mirror facet of the facet mirror.

10. The apparatus of claim 1, wherein the mirror element comprises silicon.

11. The apparatus of claim 1, wherein the mirror element comprises a nickel-coated steel body.

12. The EUV apparatus of claim 1, further comprising a carrier body on which the carrying element is arranged, wherein the carrying element is movable relative to the carrier body.

13. The apparatus of claim 12, wherein the carrying element and the carrier body are formed from the same material.

14. The EUV apparatus of claim 1, further comprising a carrier body on which the carrying element is arranged, wherein the carrying element is tiltable relative to the carrier body.

15. The apparatus of claim 14, wherein the carrying element and the carrier body are formed from the same material.

16. The apparatus of claim 1, wherein the carrying element comprises a material selected from the group consisting of Invar, copper and aluminum.

17. The apparatus of claim 1, further comprising solder which connects the mirror element and the carrying element.

18. The apparatus of claim 1, further comprising an inorganic material which connects the mirror element and the carrying element, wherein the inorganic material comprises silicon oxide bridges.

19. The apparatus of claim 1, wherein the mirror element is wedge-shaped or spherical.

20. The apparatus of claim 1, wherein the mirror element is a substantially circular lamina having a diameter within the range of between 2 mm and 15 mm.

21. The apparatus of claim 1, wherein the mirror element is a substantially circular lamina having a diameter within the range of between 8 mm 12 mm.

22. The apparatus of claim 1, further comprising a connecting material which connects the mirror element and the carrying element, wherein the connecting material has a modulus of elasticity of less than 70 MPa.

23. An apparatus, comprising:
a carrying element; and
a mirror element carried by the carrying element,
wherein:
the carrying element comprises a material having a thermal conductivity of at least 100 W/(mK);
the mirror element comprises an optically polishable material having a surface roughness of less than 0.5 nm rms in the high spatial frequency range;
the mirror element has a thickness within the range of 0.2 mm to 5 mm;
cavities define by a region between the mirror element and the carrier element;
the cavities are configured to be connected to coolant lines; and
the apparatus is an EUV projection exposure apparatus.

24. A system, comprising:
a facet mirror comprising a mirror facet; and
a carrying element which carries the mirror facet,
wherein:
the carrying element comprises a material having a thermal conductivity of at least 100 W/(mK);
the mirror facet comprises an optically polishable material having a surface roughness of less than 0.5 nm rms in the high spatial frequency range;
the mirror facet has a thickness within the range of 0.2 mm to 5 mm;
cavities define by a region between the mirror facet and the carrier element;
the cavities are configured to be connected to coolant lines; and
the system is an EUV illumination system.
